(19) United States
(12) Patent Application Publication
(10) Pub. No.: US 2026/0301685 A1
(43) Pub. Date: Oct. 1, 2026

(54) Gate Driver and Display Device Including the Same

(71) Applicant: LG Display Co., Ltd., Seoul (KR)

(72) Inventor: Woo Kyu Sang, Paju-si (KR)

(21) Appl. No.: 19/447,573

(22) Filed: Jan. 13, 2026

(30) Foreign Application Priority Data
Mar. 31, 2025 (KR) 10-2025-0041368

(51) Int. Cl. G09G 3/3266; G09G 3/3233

(52) U.S. Cl. CPC G09G 3/3266; G09G 3/3233; G09G 2300/0819; G09G 2300/0842; G09G 2310/0286; G09G 2310/0289; G09G 2310/08; G09G 2330/023; G09G 2340/0435

(57) ABSTRACT

A gate driver and a display device including the same are disclosed herein. The gate driver includes a control signal transfer part configured to generate a control signal based on a control clock signal and a carry signal, a scan signal output part configured to generate a scan signal according to potentials of a first control node and a second control node that are charged or discharged according to a gate clock signal, and a scan signal selection part configured to selectively output the scan signal generated from the scan signal output part based on the control signal transmitted from the control signal transfer part. The scan signal selection part includes a first transistor implemented as a p-channel TFT (thin film transistor) and a second transistor implemented as an n-channel TFT.

### CROSS-REFERENCE TO RELATED APPLICATION

The present application claims priority to Republic of Korea Patent Application No. 10-2025-0041368, filed on Mar. 31, 2025, which is incorporated herein by reference in its entirety.

### BACKGROUND

### Field

The present disclosure relates to a gate driver and a display device including the same.

### Discussion of Related Art

Electroluminescent display devices are divided into inorganic light emitting display devices and organic light emitting display devices according to a material of a light emitting layer. An active-matrix type organic light emitting display device includes an organic light emitting diode (hereinafter referred to as an “OLED”) which emits light by itself, and has advantages in that a response speed is fast and luminous efficiency, luminance, and a viewing angle are large.

In organic light-emitting display devices, organic light-emitting diodes (referred to as "OLEDs") are formed in each of pixels. These organic light display devices not only respond quickly and have excellent light-emitting efficiency, luminance, and viewing angle, but also have excellent contrast ratio and color reproduction rate because they can express black tones as complete black.

Some of display devices, for example, a liquid crystal display device or an organic light emitting display device includes a display panel including a plurality of sub-pixels, a driver outputting a driving signal for driving the display panel, a power supply generating power to be supplied to the display panel or the driver, and the like. The driver includes a gate driver that supplies a scan signal or a gate signal to the display panel, and a data driver that supplies a data signal to the display panel.

### SUMMARY

Recently, display devices support variable refresh rate (VRR). In a gate driver of a display device, output of gate signals is blocked during a period of skipping frames. To this end, the gate driver further includes an output control circuit for controlling whether to output gate signals.

In a gate signal selection circuit that selectively outputs a gate signal using a QB node in an output control circuit, a pull-down transistor is turned on to output the low-potential voltage. However, since the voltage of the QB node needs to be lower than the low-potential voltage, when the low-potential voltage is lowered below a previously set voltage, the driving voltage of the gate driver may increase.

The present disclosure is directed to solving all the above-described necessity and problems.

The present disclosure provides a gate driver and a display device including the same.

It should be noted that objects of the present disclosure are not limited to the above-described objects, and other objects of the present disclosure will be apparent to those skilled in the art from the following descriptions.

A gate driver according to embodiments of the present disclosure may include a control signal transfer part configured to generate a control signal based on a control clock signal and a carry signal; a scan signal output part configured to generate a scan signal according to potentials of a first control node and a second control node that are charged or discharged according to a gate clock signal; and a scan signal selection part configured to selectively output the scan signal generated from the scan signal output part based on the control signal transmitted from the control signal transfer part, wherein the scan signal selection part includes a first transistor implemented as a p-channel TFT (thin film transistor) and a second transistor implemented as an n-channel TFT, the first transistor includes a gate electrode to which the control signal is applied, a first electrode to which the scan signal is applied, and a second electrode connected to an output node, and the second transistor includes a gate electrode to which the control signal is applied, a first electrode connected to the output node, and a second electrode to which the low-potential voltage is applied.

A gate driver according to embodiments of the present disclosure may include a control signal transfer part configured to generate a control signal based on a control clock signal and a carry signal; an inverted control signal transfer part configured to generate an inverted control signal based on the control clock signal and an inverted carry signal; a scan signal output part configured to generate a scan signal according to potentials of a first control node and a second control node that are charged or discharged according to a gate clock signal; and a scan signal selection part configured to selectively output the scan signal generated from the scan signal output part based on the control signal transmitted from the control signal transfer part, wherein the scan signal selection part includes a first transistor implemented as a p-channel TFT (thin film transistor) and a second transistor implemented as a p-channel TFT, the first transistor includes a gate electrode to which the control signal is applied, a first electrode to which the scan signal is applied, and a second electrode connected to an output node, and the second transistor includes a gate electrode to which the inverted control signal is applied, a first electrode connected to the output node, and a second electrode to which the low-potential voltage is applied.

According to the present disclosure, the gate signal selection circuit is configured to apply the control signal to both the pull-up transistor and the pull-down transistor without using the voltage of the QB node in the output control circuit, it is possible to reduce power consumption by eliminating the need to lower a low-potential voltage to increase the driving voltage of the output control circuit.

The present disclosure may enable low-power driving because power consumption may be reduced.

The effects of the present disclosure are not limited to the above-mentioned effects, and other effects that are not mentioned will be apparently understood by those skilled in the art from the following description and the appended claims.

### BRIEF DESCRIPTION OF THE DRAWINGS

The above and other objects, features, and advantages of the present disclosure will become more apparent to those of ordinary skill in the art by describing exemplary embodiments thereof in detail with reference to the attached drawings, in which:

FIG. 1 is a block diagram illustrating a display device according to one or more embodiments of the present disclosure.

FIG. 2 is a circuit diagram illustrating a pixel circuit according to one or more embodiments of the present disclosure.

FIG. 3 includes waveform diagrams illustrating driving signals applied to the pixel circuit illustrated in FIG. 2 during a refresh frame period and a skip frame period.

FIG. 4 is a circuit diagram illustrating a pixel circuit according to one or more other embodiments of the present disclosure.

FIG. 5 includes waveform diagrams illustrating driving signals applied to the pixel circuit illustrated in FIG. 4 during a refresh frame period and a skip frame period.

FIG. 6 is a diagram illustrating an example of a display panel driven at multiple frequencies during one frame period according to one or more embodiments of the present disclosure.

FIG. 7 is a diagram illustrating an arrangement form of a gate driver according to one or more embodiments of the present disclosure.

FIG. 8 is a block diagram illustrating a gate driver according to a first embodiment of the present disclosure.

FIG. 9 is a diagram illustrating driving waveforms of the gate driver illustrated in FIG. 8.

FIGS. 10-13 are diagrams illustrating detailed circuits of the gate driver illustrated in FIG. 8.

FIG. 14 is a diagram illustrating an arrangement form of a gate driver according to a second embodiment of the present disclosure.

FIG. 15 is a block diagram illustrating a gate driver according to the second embodiment of the present disclosure.

FIG. 16 is a diagram illustrating driving waveforms of the gate driver illustrated in FIG. 15.

FIGS. 17-19 are diagrams illustrating detailed circuits of the gate driver illustrated in FIG. 15.

### DETAILED DESCRIPTION

Advantages and features of the present disclosure and methods of achieving them will become apparent with reference to preferable embodiments, which are described in detail, in conjunction with the accompanying drawings. However, the present disclosure is not limited to the embodiments to be described below and may be implemented in different forms, the embodiments are only provided to completely disclose the present disclosure and completely convey the scope of the present disclosure to those skilled in the art, and the present disclosure is defined by the disclosed claims.

Since the shapes, sizes, proportions, angles, numbers, and the like disclosed in the drawings for describing the embodiments of the present disclosure are only exemplary, the present disclosure is not limited to the illustrated items. The same reference numerals indicate the same components throughout the disclosure. Further, in describing the present disclosure, when it is determined that a detailed description of related known technology may unnecessarily obscure the gist of the present disclosure, the detailed description thereof will be omitted.

When ‘including,’ ‘having,’ ‘comprising,’ and the like mentioned in the present disclosure are used, other parts may be added unless ‘only’ is used. A case in which a component is expressed in a singular form includes a plural form unless explicitly stated otherwise.

In interpreting the components, it should be understood that an error range is included even when there is no separate explicit description.

In the case of a description of a positional relationship, for example, when the positional relationship of two parts is described as ‘on,’ ‘at an upper portion,’ ‘at a lower portion,’ ‘next to, and the like, one or more other parts may be located between the two parts unless ‘immediately’ or ‘directly’ is used.

Although first, second, and the like are used to describe various components, these components are not limited by these terms. These terms are only used to distinguish one component from another. Accordingly, a first component, which is mentioned, below may also be a second component within the technical spirit of the present disclosure.

The same reference numerals may refer to substantially the same elements throughout the present disclosure.

The following embodiments can be partially or entirely bonded to or combined with each other and can be linked and operated in technically various ways. The embodiments can be carried out independently of or in association with each other.

Hereinafter, various embodiments of the present disclosure will be described in detail with reference to the accompanying drawings.

In a display device of the present disclosure, the pixel circuit and the gate driving circuit may include a plurality of transistors. Transistors may be implemented as oxide thin film transistors (oxide TFTs) including an oxide semiconductor, low temperature polysilicon (LTPS) TFTs including low temperature polysilicon, or the like.

A gate signal swings between a gate-on voltage and a gate-off voltage. The gate-on voltage is set to a voltage higher than a threshold voltage of a transistor, and the gate-off voltage is set to a voltage lower than the threshold voltage of the transistor.

The transistor is turned on in response to the gate-on voltage and is turned off in response to the gate-off voltage. In the case of the n-channel transistor, a gate-on voltage may be a gate high voltage, and a gate-off voltage may be a gate low voltage. In the case of the p-channel transistor, a gate-on voltage may be a gate low voltage, and a gate-off voltage may be a gate high voltage.

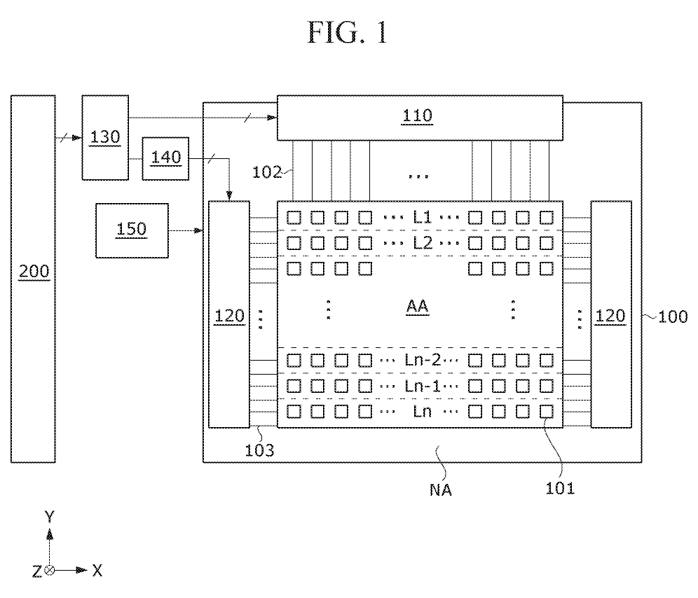

FIG. 1 is a block diagram illustrating a display device according to one or more embodiments of the present disclosure.

Referring to FIG. 1, the display device according to one or more embodiments of the present disclosure includes a display panel 100, and a display panel driving circuit for writing pixel data to pixels of the display panel 100. Additionally, the display device includes a power supply 150.

The display panel 100 may be, but not limited to, a panel having a rectangular structure with a length in the X-axis direction, a width in the Y-axis direction, and a thickness in the Z-axis direction. For example, the display panel 100 may be a heterogeneous panel of which at least a portion is curved or elliptical.

The display area AA of the display panel 100 includes a pixel array to display an input image. The pixel array includes a plurality of data lines 102, a plurality of gate lines 103 crossing the data lines 102, and pixels arranged in a matrix form. The display panel 100 may further include power lines commonly connected to the pixels. The power lines may be commonly connected to pixel circuits to supply a voltage required for driving pixels 101 to the pixels 101.

Each of the pixels 101 may be divided into a red sub-pixel, a green sub-pixel, and a blue sub-pixel for color implementation. Each pixel may further include a white sub-pixel. Each sub-pixel includes a pixel circuit for driving a light emitting element. The light emitting element may include an OLED or an inorganic light emitting diode (LED). Each pixel circuit is connected to the data lines, the gate lines, and the power lines. In the following description, a pixel may be interpreted as a sub-pixel.

The display area AA includes a plurality of pixel lines L1 to Ln. Each of the pixel lines L1 to Ln includes one line of pixels arranged along the line direction (X-axis direction) in the pixel array of the display panel 100. Those pixels arranged in one pixel line share the gate lines 103. The sub-pixels arranged in the column direction Y along the data line direction share the same data line 102. One horizontal period is a time obtained by dividing one frame period by the total number of pixel lines L1 to Ln. In one or more embodiments where a plurality of gate signals is applied to each of the pixels, the gate driver 120 may include a plurality of shift registers. The gate signals may include scan signals and light emission signals (or EM signals) input to the pixel circuit through a plurality of gate lines.

The display panel 100 may be implemented with a non-transmissive display panel or a transmissive display panel. The transmissive display panel may be applied to a transparent display device in which an image is displayed on the screen and a real object in the background is visible. The display panel 100 may be made of a flexible display panel.

The power supply 150 receives an input voltage applied from the host system 200 and outputs a voltage needed to drive the pixels 101 of the display panel 100 and the display panel driving circuit. To this end, the power supply 150 may include a direct current to direct current converter (DC-DC converter). The DC-DC converter may include a charge pump, a regulator, a buck converter, a boost converter, and the like. The power supply 150 may output a constant voltage (or direct current voltage), such as gate-on voltage, gate-off voltage, pixel driving voltage, cathode voltage, reference voltage, IC driving voltage of the display panel driving circuit, through the DC-DC converter. The gate-on voltage and the gate-off voltage may be supplied to the level shifter 140 and the gate driver 120. Voltages such as pixel driving voltage, cathode voltage, and reference voltage may be supplied to the pixels 101 through the power lines commonly connected to the pixels 101.

The display panel driving circuit writes pixel data of the input image to the pixels 101 of the display panel 100 under the control of the timing controller 130. The display panel driving circuit includes a data driver 110 and a gate driver 120.

The display panel driving circuit may further include a touch sensor driver for driving touch sensors. The touch sensor driver is not shown in FIG. 1. The data driver 110 and the touch sensor driver may be integrated into one source drive IC.

The data driver 110 receives pixel data of the input image as a digital signal from the timing controller 130 and outputs a data voltage. The data driver 110 may receive gamma reference voltages and generate gamma compensation voltages for each grayscale through a voltage dividing circuit. The per-grayscale gamma compensation voltages are supplied to a digital to analog converter (hereinafter referred to as “DAC”) disposed in each channel of the data driver 110.

The data driver 110 samples and latches digital data received from the timing controller 130 and then inputs the digital data to the DAC. Here, the digital data includes pixel data of the input image. The DAC converts the pixel data into a gamma compensation voltage and outputs a data voltage of the pixel data.

The gate driver 120 may be formed on the display panel 100 together with the circuit elements and wiring lines of the display area AA. The gate driver 120 may be disposed in at least one of left and right non-display areas NA outside the display area AA in the display panel 100 or at least a part thereof may be disposed within the display area AA.

The gate driver 120 may be provided in the non-display areas NA on both sides of the display panel 100 with the display area AA of the display panel interposed therebetween and may supply gate pulses on both sides of the gate lines 103 by a double feeding method. The gate driver 120 sequentially outputs pulses of gate signals to the gate lines 103 under the control of the timing controller 130. The gate driver 120 may sequentially supply the gate signals to the gate lines 103 by shifting the pulses of the gate signals using a shift register or an edge trigger. The gate driver 120 may include a plurality of gate drivers. Each of the gate drivers may be implemented as a shift register or an edge trigger.

The gate driver 120 may include a scan driver, and an EM driver.

The scan driver outputs a scan signal SCAN in response to a start pulse and a shift clock output from the timing controller 130, and shifts the scan signal SCAN in sync with a shift clock timing. The EM driver outputs an EM signal EM in response to the start pulse and the shift clock output from the timing controller 130, and sequentially shifts the EM signal EM according to the shift clock. Accordingly, the scan signal SCAN, and the EM signal EM are sequentially supplied to the gate lines 103 of the pixel lines L1 to Ln.

The timing controller 130 receives digital video data of an input image and a timing signal synchronized with this data from the host system 200. The timing signal may include a vertical synchronization signal Vsync, a horizontal synchronization signal Hsync, and a data enable signal DE. Since the vertical period and horizontal period may be known by counting the data enable signal DE, the vertical synchronization signal Vsync and the horizontal synchronization signal Hsync may be omitted. The horizontal synchronization signal Hsync and the data enable signal DE have a periodicity of 1 horizontal period (1H).

The timing controller 130 may control the display panel driving circuit by generating a data timing control signal for controlling the operation timing of the data driver 110 and a gate timing control signal for controlling the operation timing of the gate driver 120 based on the timing signals Vsync, Hsync, DE received from the host system 200. The timing controller 130 may synchronize the data driver 110 and the gate driver 120 by controlling the operation timing of the display panel driving circuit.

The gate timing control signal output from the timing controller 130 may be input to the shift register of the gate driver 120 through the level shifter 140. The level shifter 140 may convert a voltage of the gate timing control signal received from the timing controller 130 to a swing width between the gate-on voltage and the gate-off voltage and supply it to the gate driver 120.

The timing controller 130 may analyze an input image for each frame, generate a clock signal for controlling the output control circuit that selectively outputs gate signals according to the analyzed result, and provide the generated clock signal to the shift registers of the gate driver 120 through a level shifter 140.

For example, the timing controller 130 may compare an image of a previous frame with an image of a current frame and identify pixel positions where the image changes according to the comparison result. The timing controller 130 may divide the display area into a plurality of sub-display areas based on the identified pixel positions and generate a clock signal for this purpose.

Here, an example is described in which the timing controller identifies the positions of pixels where an image changes, but the present disclosure is not limited thereto. For example, a host system may identify the positions of pixels where an image changes and provide the identified pixel positions to the timing controller.

The host system 200 may scale an image signal from a video source according to the resolution of the display panel 100, and may transmit it to the timing controller 130 together with the timing signals.

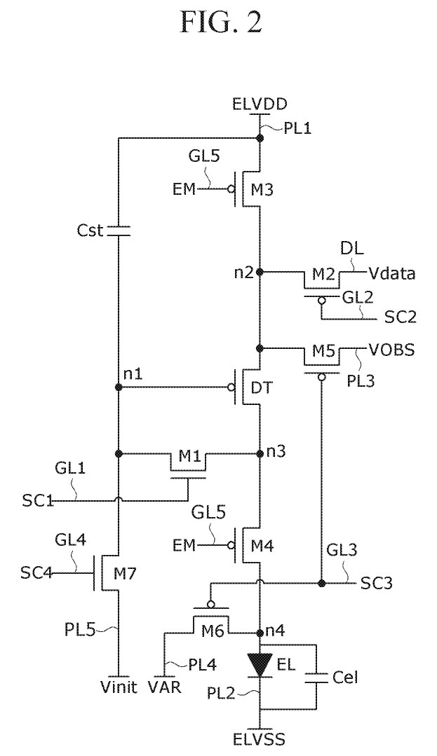

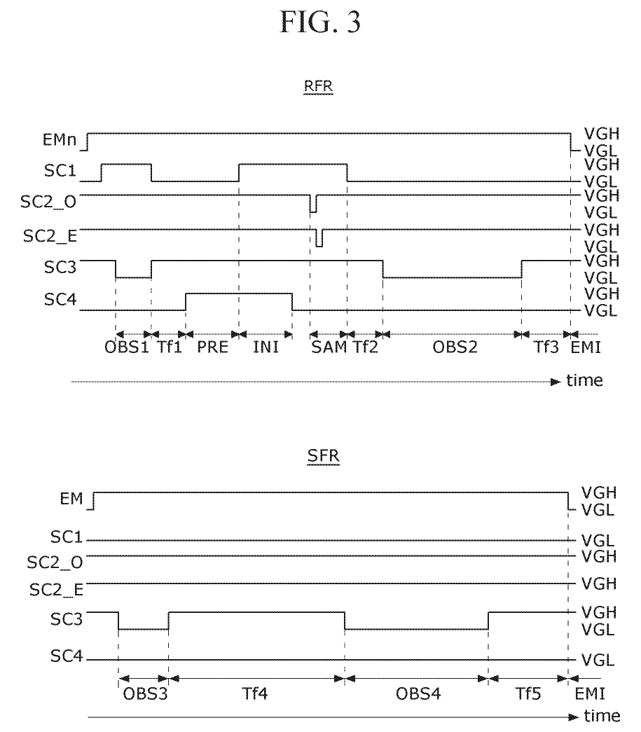

FIG. 2 is a circuit diagram illustrating a pixel circuit according to one or more embodiments of the present disclosure. FIG. 3 includes waveform diagrams illustrating driving signals applied to the pixel circuit illustrated in FIG. 2 during a refresh frame period and a skip frame period. In FIG. 3, a second scan signal SC2_O is a gate signal that is applied to subpixels of an odd-numbered pixel line in synchronization with an odd-numbered data voltage Vdata_O. A second scan signal SC2_E is a gate signal that is applied to subpixels of an even-numbered pixel line in synchronization with an even-numbered data voltage Vdata_E.

Referring to FIGS. 2 and 3, the pixel circuit includes a light-emitting element EL, a driving element DT that drives the light-emitting element EL, a plurality of switch elements M1 to M7, and a capacitor Cst.

Each of first and seventh switch elements M1 and M7 may be implemented as an n-channel oxide TFT. Each of the driving element DT and second, third, fourth, fifth, and sixth switch elements M2, M3, M4, M5, and M6 may be implemented as a p-channel LTPS TFT. The first and seventh switch elements M1 and M7 are turned on in response to a gate high voltage VGH of a corresponding gate signal in FIG. 3, and are turned off in response to a gate low voltage VGL of the corresponding gate signal. The second, third, fourth, fifth, and sixth switch elements M2, M3, M4, M5, and M6 are turned on in response to a gate low voltage VGL of a corresponding gate signal in FIG. 3, and are turned off in response to a gate high voltage VGH of the corresponding gate signal.

The driving element DT includes a gate electrode connected to a first node n1, a first electrode connected to a second node n2, and a second electrode connected to a third node n3. The capacitor Cst is connected between a first power line PL1 to which the pixel driving voltage ELVDD is applied and the first node n1, and suppresses fluctuation of a gate-source voltage Vgs of the driving element DT.

The light-emitting element EL includes an anode electrode connected to a fourth node n4 and a cathode electrode connected to a second power line PL2 to which the pixel ground voltage ELVSS is applied. The light-emitting element EL may be implemented as an OLED. The OLED includes the parasitic capacitance Cel due to a stacked structure.

The first switch element M1 is connected between the first node n1 and the third node n3, and is turned on in response to the gate high voltage VGH of the first scan signal SC1. When the first switch element M1 is turned on, the first node n1 is electrically connected to the third node n3. The second switch element M2 is connected between the data line DL and the second node n2, and is turned on in response to the gate low voltage VGL of the second scan signal SC2. When the second switch element M2 is turned on, the data line DL is electrically connected to the second node n2.

The third switch element M3 is connected between the first power line PL1 and the second node n2, and is turned on in response to the gate low voltage VGL of the EM signal EM. When the third switch element M3 is turned on, the pixel driving voltage ELVDD is applied to the second node n2. The fourth switch element M4 is connected between the third node n3 and the fourth node n4, and is turned on in response to the gate low voltage VGL of the EM signal EM. When the fourth switch element M4 is turned on, the third node n3 is electrically connected to the fourth node n4.

The fifth switch element M5 is connected between the second node n2 and a third power line PL3 to which the on bias voltage VOBS is applied, and is turned on in response to the gate low voltage VGL of the third scan signal SC3. When the fifth switch element M5 is turned on, the on bias voltage VOBS is applied to the second node n2. The sixth switch element M6 is connected between the fourth node n4 and a fourth power line PL4 to which the second initialization voltage VAR is applied, and is turned on in response to the gate low voltage VGL of the third scan signal SC3. When the sixth switch element M6 is turned on, the second initialization voltage VAR is applied to the anode electrode of the light-emitting element EL connected to the fourth node n4.

The on bias voltage VOBS is an on bias stress voltage that is applied to the driving element DT to reduce a difference in hysteresis characteristic when the driving element DT is turned on/off. The on bias voltage VOBS is lower than the pixel driving voltage ELVDD and may be varied within a voltage range partially overlapping the dynamic range of the data voltage Vdata. For example, when the dynamic range of the data voltage Vdata is 2 [V] to 6 [V], the on bias voltage VOBS may be varied in a range of 4 [V] to 8 [V].

The second initialization voltage VAR discharges the parasitic capacitance (Cel) of the light-emitting element (EL) to reset the anode voltage of the light-emitting element (EL). A luminance level of the pixels 101 at a low grayscale may be optimized by appropriately adjusting the anode voltage according to the second initialization voltage VAR. The second initialization voltage VAR may be varied. For example, when the dynamic range of the data voltage Vdata is 2 [V] to 6 [V], the second initialization voltage VAR may be varied in a range of -4 [V] to -5 [V].

The seventh switch element M7 is connected between the first node n1 and a fifth power line PL5 to which the first initialization voltage Vinit is applied, and is turned on in response to the gate high voltage VGH of the fourth scan signal SC4. When the seventh switch element M7 is turned on, the first initialization voltage Vinit is applied to the capacitor Cst connected to the first node n1 and the gate electrode of the driving element DT.

The pixel circuit may receive the refresh driving signals as input, may be charged to the data voltage of the pixel data, and may be driven at the refresh frequency during the refresh frame period RFR. The refresh frame period RFR may be divided into a first on bias period OBS1, a first initialization period PRE, a second initialization period INI, a sampling period SAM, a second on bias period OBS2, and an emission period EMI.

A first floating period Tf1 may be set between the first on bias period OBS1 and the first initialization period PRE. A second floating period Tf2 may be set between the sampling period SAM and the second on bias period OBS2. A third floating period Tf3 may be set between the second on bias period OBS2 and the emission period EMI. During the floating periods Tf1, Tf2, and Tf3, since all the first to seventh switch elements M1 to M7 are in an off state, the first to fourth nodes n1, n2, n3, and n4 are brought into a floating state and maintained in previous state.

During the first on bias period OBS1, the fifth and sixth switch elements M5 and M6 are turned on, the on bias voltage VOBS is applied to the second node n2, and the second initialization voltage VAR is applied to the fourth node n4. During the first on bias period OBS1, the first switch element M1 is turned on, and the first node n1 is electrically connected to the third node n3.

During the first initialization period PRE, the seventh switch element M7 is turned on, and the initialization voltage Vinit is applied to the first node n1. During the first initialization period PRE, the light-emitting element EL is in an off state and does not emit light. During the second initialization period INI, the first and seventh switch elements M1 and M7 are turned on, the initialization voltage Vinit is applied to the first and third nodes n1 and n3, and the initialization voltage Vinit is also applied to the second node n2 via the driving element DT that is maintained in an on state.

During the sampling period SAM, the second switch element M2 is turned on in response to the gate low voltage VGL of the second scan signal SC2. In this case, the data voltage Vdata is applied to the second node n2, and the data voltage Vdata is applied to the first and third nodes n1 and n3 via the driving element DT in the on state. During the second on bias period OBS2, the fifth and sixth switch elements M5 and M6 are turned on, the on bias voltage VOBS is applied to the second node n2, and the second initialization voltage VAR is applied to the fourth node n4.

During the emission period EMI of the refresh frame period RFR, the third and fourth switch elements M3 and M4 are turned on in response to the gate low voltage VGL of the EM signal EM. During the emission period EMI, a current path may be formed between the pixel driving voltage ELVDD and the light-emitting element EL via the third and fourth switch elements M3 and M4, and the light-emitting element EL may emit light with luminance corresponding to a grayscale value of pixel data.

The pixel circuit may receive the skip driving signals as input, charge a voltage of pixel data, and may be driven at the skip driving frequency during the skip frame period SFR. The skip frame period SFR may be divided into a third on bias period OBS3, a fourth on bias period OBS4, and an emission period EMI. A fourth floating period Tf4 may be set between the third on bias period OBS3 and the fourth on bias period OBS4. A fifth floating period Tf5 may be set between the fourth on bias period OBS4 and the emission period EMI. During the fourth and fifth floating periods TF4 and Tf5, since all the first to seventh switch elements M1 to M7 are in the off state, the first to fourth nodes n1, n2, n3, and n4 are brought into the floating state.

During the third and fourth on bias periods OBS3 and OBS4, the fifth and sixth switch elements M5 and M6 are turned on, the on bias voltage VOBS is applied to the second node n2, and the second initialization voltage VAR is applied to the fourth node n4.

During the emission period EMI of the skip frame period SFR, the third and fourth switch elements M3 and M4 are turned on in response to the gate low voltage VGL of the EM signal EM. During the emission period EMI, a current path may be formed between the pixel driving voltage ELVDD and the light-emitting element EL via the third and fourth switch elements M3 and M4, and the light-emitting element EL may emit light with luminance corresponding to a grayscale value of pixel data.

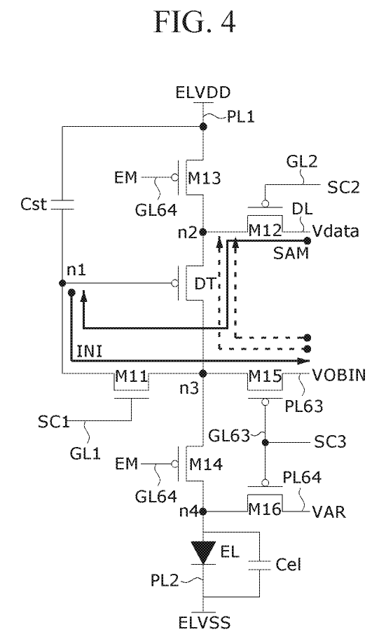

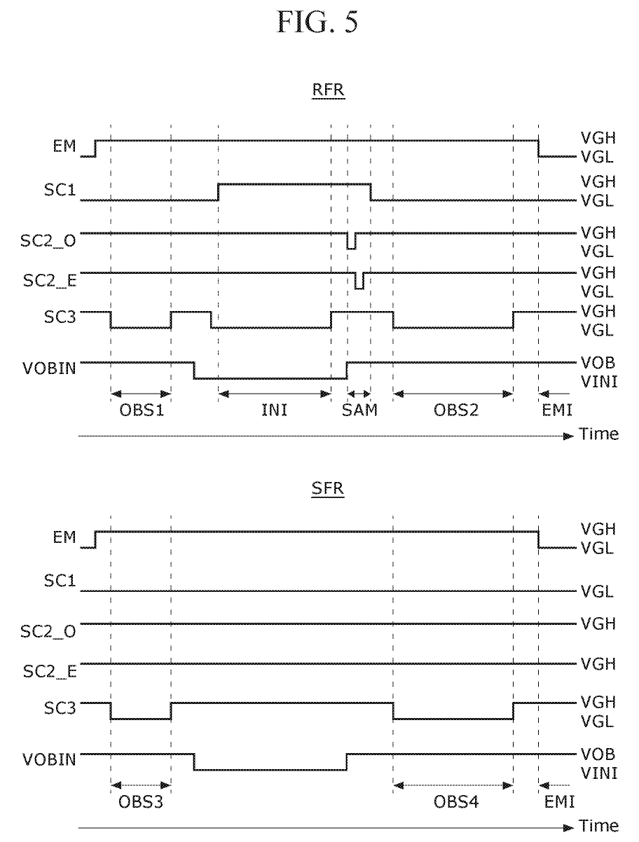

FIG. 4 is a circuit diagram illustrating a pixel circuit according to one or more other embodiments of the present disclosure. FIG. 5 includes waveform diagrams illustrating driving signals applied to the pixel circuit illustrated in FIG. 4 during a refresh frame period and a skip frame period.

Referring to FIGS. 4 and 5, the pixel circuit includes a light-emitting element EL, a driving element DT that drives the light-emitting element EL, a plurality of switch elements M11 to M16, and a capacitor Cst. The pixel circuit is connected to a data line DL, gate lines GL1, GL2, GL63, and GL64, and power lines PL1, PL2, PL63, and PL64.

A first switch element M11 may be implemented as an n-channel oxide TFT. Each of the driving element DT and second, third, fourth, fifth, and sixth switch elements M12, M13, M14, M15, and M16 may be implemented as a p-channel LTPS TFT. The first switch element T1 is turned on in response to a gate high voltage VGH of a first scan signal SC1 and is turned off in response to a gate low voltage VGL of the first scan signal SC1 in FIG. 5. The second, third, fourth, fifth, and sixth switch elements M12, M13, M14, M15, and M16 are turned on in response to gate low voltages VGL of corresponding gate signals SC2, SC3, and EM and are turned off in response to gate high voltages VGH of the corresponding gate signals SC2, SC3, and EM in FIG. 5.

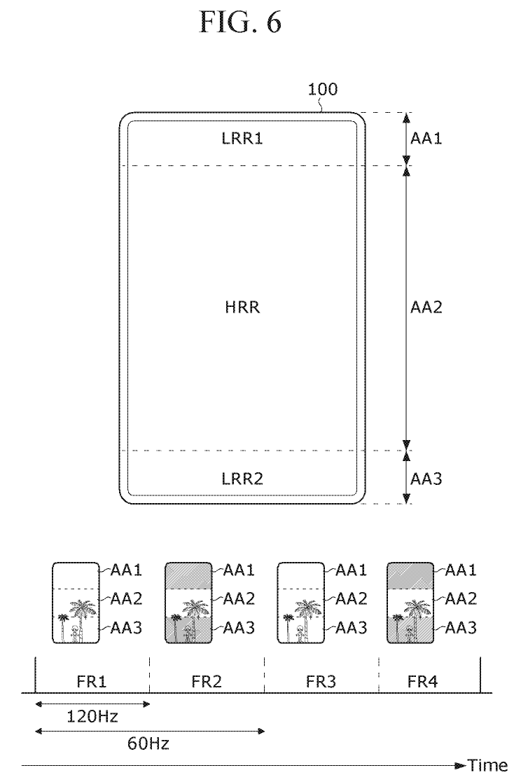

The first switch element M11 is connected between a first node n1 and a third node n3, and is turned on in response to the gate high voltage VGH of the first scan signal SC1 in an initialization period INI and a sampling period SAM of a refresh frame period RFR as illustrated in FIG. 6.

When the first switch element M11 is turned on, the first node n1 is electrically connected to the third node n3.

The second switch element M12 is connected between the data line DL and a second node n2, and is turned on in response to the gate low voltage VGL of the second scan signal SC2 in the sampling period SAM of the refresh frame period RFR as illustrated in FIG. 5. When the second switch element M12 is turned on, the data line DL is electrically connected to the second node n2.

The third switch element M13 is connected between the first power line PL1 and the second node n2, and is turned on in response to the gate low voltage VGL of the EM signal EM in an emission period EMI as illustrated in FIG. 5. When the third switch element M13 is turned on, the pixel driving voltage ELVDD is applied to the second node n2.

The fourth switch element M14 is connected between the third node n3 and a fourth node n4, and is turned on in response to the gate low voltage VGL of the EM signal EM in the emission period EMI as illustrated in FIG. 5. When the fourth switch element M14 is turned on, the third node n3 is electrically connected to the fourth node n4.

The fifth switch element M15 is connected between the third node n3 and a third power line PL63 to which a compensation voltage VOBIN is applied, and is turned on in response to the gate low voltage VGL of the third scan signal SC3. The compensation voltage VOBIN is an alternating-current voltage that swings between an on bias voltage VOB and an initialization voltage VINI as illustrated in FIG. 5. The on bias voltage VOB is a voltage higher than the initialization voltage VINI. The on bias voltage VOB is applied to the third node n3 via the fifth switch element T5 during on bias periods OBS1 to OBS5. The initialization voltage VINI is applied to the third node n3 via the fifth switch element M15 during the initialization period INI. The on bias voltage VOB corresponds to the on bias voltage VOBS in the above-described embodiment, and the initialization voltage VINI corresponds to the first initialization voltage Vinit in the above-described embodiment.

The sixth switch element M16 is connected between the fourth node n4 and a fourth power line PL64, and is turned on in response to the gate low voltage VGL of the third scan signal SC3. The second initialization voltage VAR is applied to the fourth node n4 via the sixth switch element M16 during the on bias periods OBS1 to OBS4.

FIG. 6 is a diagram illustrating an example of a display panel driven at multiple frequencies during one frame period according to one or more embodiments of the present disclosure.

Referring to FIG. 6, a display area AA of the display panel 100 may be divided into multiple sub-display areas AA1, AA2, and AA3 and may reproduce an input image at different refresh rates in one frame period. In the display panel 100, the sub-display areas AA1, AA2, and AA3 mean local pixel areas that are not physically separated and in which driving frequencies of pixels are controlled independently according to the refresh rates. The sub-display areas AA1, AA2, and AA3 include pixels and signal wires having substantially the same structures. When the pixels of the sub-display areas AA1, AA2, and AA3 are driven at a variable refresh rate, the sub-display areas AA1, AA2, and AA3 are local areas having the pixels with different driving frequencies in the display area AA.

In the normal driving mode, all areas AA1, AA2, and AA3 may be driven at the same refresh driving frequency, for example, 120 Hz.

In the multi-frequency driving mode, the first and third areas AA1 and AA3 may be driven at a skip driving frequency, for example, 60 Hz, and the second region AA2 may be driven at a refresh driving frequency, for example, 120 Hz.

The refresh driving frequency is a driving frequency of a pixel that occurs when pixel data is written as much as Frames Per Second (FPS) that changes according to a variable refresh rate. The skip driving frequency is a driving frequency of a pixel that maintains a data voltage of pixel data charged in a previous refresh frame without new pixel data being written. Therefore, when pixels are skip-driven, since there are no initialization and data writing steps for the pixels, power consumption in the display panel 100 and the display panel driving circuit during skip driving may be significantly lower than during refresh driving.

In one or more embodiments of the present disclosure, the normal driving mode refers to a mode in which a plurality of gate signals is sequentially output in the entire display area and all pixels are driven in a refresh frame period. The multi-frequency driving mode may refer to a mode in which a gate signal is maintained at a low voltage level in some display areas and the corresponding pixels in those areas are driven in a skip frame period.

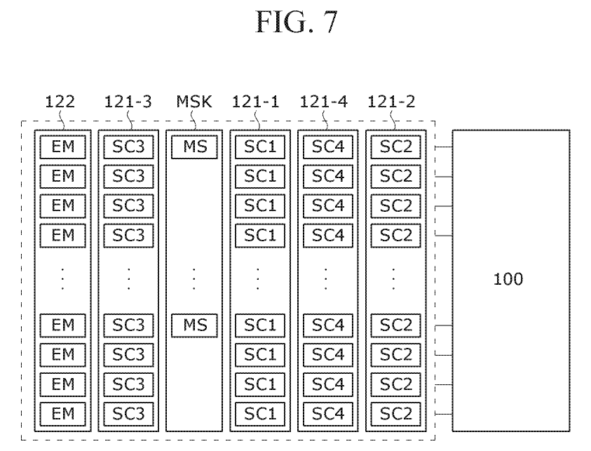

FIG. 7 is a diagram illustrating an arrangement form of a gate driver according to one or more embodiments of the present disclosure.

Referring to FIG. 7, the gate driver according to an embodiment of the present disclosure may include a first scan driver 121-1, a second scan driver 121-2, a third scan driver 121-3, a fourth scan driver 121-4, and an EM driver 122. In addition, the embodiment further includes an output controller MSK that controls whether to output the first and second scan signals and the fourth scan signal.

In the multi-frequency driving mode, the first scan driver 121-1, the second scan driver 121-2, and the fourth scan driver 121-4 are controlled by a control signal MS generated from the output controller MSK so that a first scan signal SC1, a second scan signal SC2, and a fourth scan signal SC4 among first to fourth scan signals SC1, SC2, SC3, and SC4 and an EM signal EM are not output to the pixel circuit of FIG. 2 driven in a skip frame period.

The output controller MSK may be disposed on a per-block basis, wherein each block includes a predetermined number of gate drivers, so that the same control signal can be provided to a plurality of gate drivers, but is not limited thereto. For example, the output controller MSK may be disposed one for each gate driver so as to provide a control signal to each gate driver.

In the following, the first scan driver 121-1 and the fourth scan driver 121-4 will be described. Since the first scan driver 121-1 and the fourth scan driver 121-4 have the same configuration and operating principle, only the driving and operation of the first scan driver 121-1 will be described.

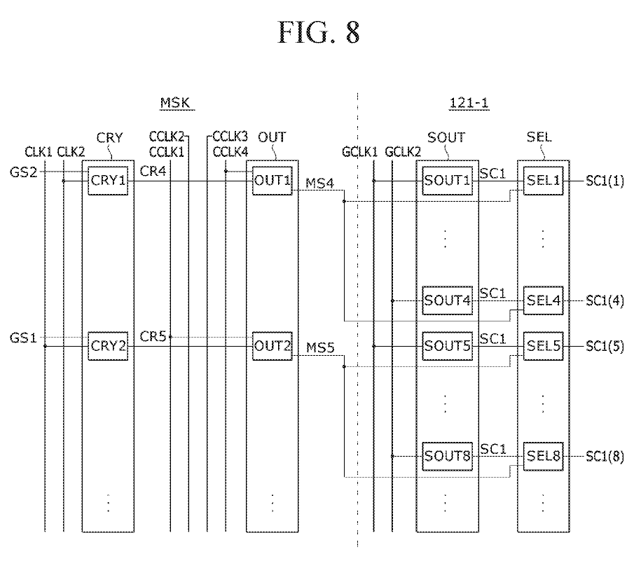

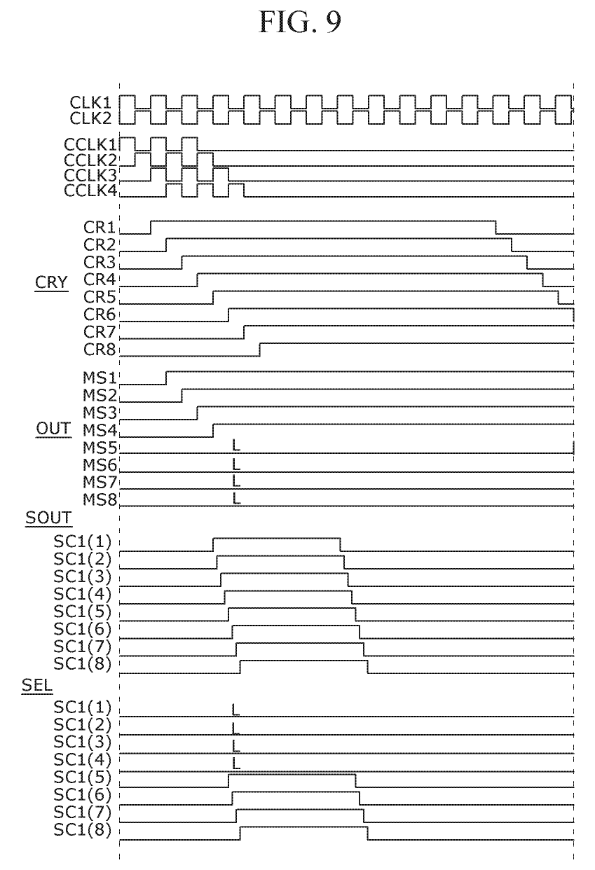

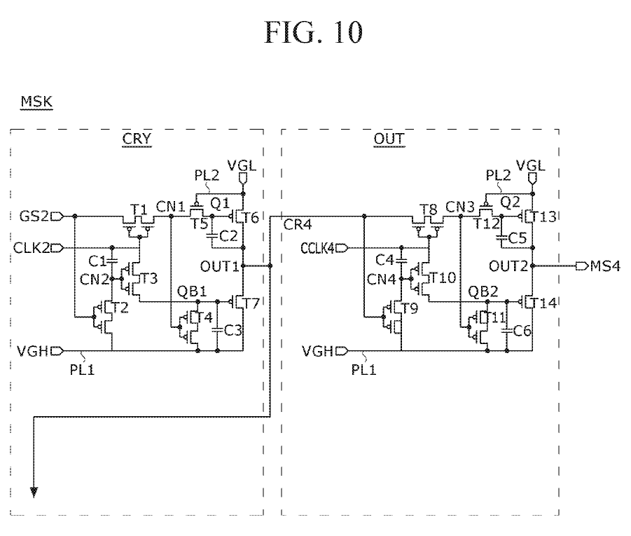

FIG. 8 is a block diagram illustrating a gate driver according to a first embodiment of the present disclosure. FIG. 9 is a diagram illustrating driving waveforms of the gate driver illustrated in FIG. 8. FIGS. 10-13 are diagrams illustrating detailed circuits of the gate driver illustrated in FIG. 8.

Referring to FIGS. 8-9, a gate driver according to a first embodiment of the present disclosure may include an output controller MSK and a first scan driver 121-1 that outputs a first scan signal. The output controller MSK may include a carry signal transfer part CRY and a control signal transfer part OUT.

The carry signal transfer part CRY may receive selected gate signals GS1 and GS2 and clock signals CLK1 and CLK2. The gate signals GS1 and GS2 may be output from another gate driver and may be gate signals that are sequentially shifted on a pixel line basis, for example, they may be EM signals or separate gate signals. The carry signal transfer part CRY may output carry signals CR4 and CR5 under the control of the timing controller.

The control signal transfer part OUT may receive the carry signals CR4 and CR5 and modulated control clock signals CCLK1, CCLK2, CCLK3, and CCLK4, and output control signals MS4 and MS5.

As shown in FIG. 9, the control signal transfer part OUT outputs only control signals MS1, MS2, MS3, and MS4 by the modulated control clock signals CCLK1, CCLK2, CCLK3, and CCLK4 in the multi-frequency driving mode. The modulated control clock signals CCLK1, CCLK2, CCLK3, and CCLK4 may be generated by the timing controller.

Referring to FIG. 10, which illustrates an example of a fourth signal transfer part included in the output controller MSK of the present disclosure, the output controller may include a carry signal transfer part CRY and a control signal transfer part OUT.

The carry signal transfer part CRY outputs a carry signal CR4 using a gate signal GS2 and a clock signal CLK2. The carry signal transfer part CRY includes a first transistor T1, a second transistor T2, a third transistor T3, a fourth transistor T4, a fifth transistor T5, a sixth transistor T6, a seventh transistor T7, a first capacitor C1, a second capacitor C2, and a third capacitor C3.

The first transistor T1 is turned on according to the clock signal CLK2 and applies the gate signal GS2 to a first connection node CN1. The first transistor T1 includes a gate electrode to which the clock signal CLK2 is applied, a first electrode to which the gate signal GS2 is applied, and a second electrode connected to the first connection node CN1.

The second transistor T2 is turned on according to the gate signal GS2, and connects a second connection node CN2 to a first power line PL1 to which a high-potential voltage VGH is applied, thereby charging the second connection node CN2 to the high-potential voltage VGH. The second transistor T2 includes a gate electrode to which the gate signal GS2 is applied, a first electrode connected to the second connection node CN2, and a second electrode connected to the first power line PL1.

The third transistor T3 is turned on according to the potential of the second connection node CN2 and applies the clock signal CLK2 to a QB1 node QB1. The third transistor T3 includes a gate electrode connected to the second connection node CNb, a first electrode to which the clock signal CLK2 is applied, and a second electrode connected to the QB1 node QB1.

The fourth transistor T4 is turned on according to the potential of the first connection node CN1, and connects the first power line PL1 to the QB1 node QB1, thereby charging the QB1 node QB1 to the high-potential voltage VGH. The fourth transistor T4 includes a gate electrode connected to the first connection node CN1, a first electrode connected to the QB1 node QB1, and a second electrode connected to the first power line PL1.

The first to fourth transistors T1, T2, T3, and T4 may have a dual gate structure to minimize or at least reduce current leakage.

The fifth transistor T5 is turned on according to the potential of the low-potential voltage VGL and connects the first connection node CN1 to a Q1 node Q1. The fifth transistor T5 includes a gate electrode connected to a second power line PL2 to which the low-potential voltage VGL is applied, a first electrode connected to the first connection node CN1, and a second electrode connected to the Q1 node Q1.

The sixth transistor T6 is turned on according to the potential of the Q1 node Q1 and outputs the low-potential voltage VGL to a first output node OUT1. The sixth transistor T6 includes a gate electrode connected to the Q1 node Q1, a first electrode connected to the second power line PL2, and a second electrode connected to the first output node OUT1.

The seventh transistor T7 is turned on according to the potential of the QB1 node QB1 and outputs the high-potential voltage VGH to the first output node OUT1. The seventh transistor T7 includes a gate electrode connected to the QB1 node QB1, a first electrode connected to the first output node OUT1, and a second electrode connected to the first power line PL1.

The first capacitor C1 is connected between the gate electrode and the first electrode of the third transistor T3. The second capacitor C2 is connected between the gate electrode and the second electrode of the sixth transistor T6. The third capacitor C3 is connected between the gate electrode and the second electrode of the seventh transistor T7.

The control signal transfer part OUT outputs a control signal MS4 based on the carry signal CR4 and a modulated control clock signal CCLK4. The control signal transfer part OUT includes an eighth transistor T8, a ninth transistor T9, a tenth transistor T10, an eleventh transistor T11, a twelfth transistor T12, a thirteenth transistor T13, a fourteenth transistor T14, a fourth capacitor C4, a fifth capacitor C5, and a sixth capacitor C6.

The eighth transistor T8 is turned on according to a control clock signal CCLK4 and applies the carry signal CR4 to a third connection node CN3. The eighth transistor T8 includes a gate electrode to which the modulated control clock signal CCLK4 is applied, a first electrode to which the carry signal CR4 is applied, and a second electrode connected to the third connection node CN3.

The ninth transistor T9 is turned on according to the carry signal CR4, and connects the fourth connection node CN4 to the first power line PL1 to which the high-potential voltage VGH is applied, thereby charging a fourth connection node CN4 to the high-potential voltage VGH. The ninth transistor T9 includes a gate electrode to which the carry signal CR4 is applied, a first electrode connected to the fourth connection node CN4, and a second electrode connected to the first power line PL1.

The tenth transistor T10 is turned on according to the potential of the fourth connection node CN4 and applies the control clock signal CCLK4 to a QB2 node QB2. The tenth transistor T10 includes a gate electrode connected to the fourth connection node CN4, a first electrode to which the control clock signal CCLK4 is applied, and a second electrode connected to the QB2 node QB2.

The eleventh transistor T11 is turned on according to the potential of the third connection node CN3, and connects the QB2 node QB2 to the first power line PL1, thereby charging the QB2 node QB2 to the high-potential voltage VGH. The eleventh transistor T11 includes a gate electrode connected to the third connection node CN3, a first electrode connected to the QB2 node QB2, and a second electrode connected to the first power line PL1.

The eighth to eleventh transistors T8, T9, T10, and T11 may have a dual gate structure to minimize or a least reduce current leakage.

The twelfth transistor T12 is turned on according to the potential of the low-potential voltage VGL and connects the third connection node CN3 to a Q2 node Q2. The twelfth transistor T12 includes a gate electrode connected to a second power line PL2 to which the low-potential voltage VGL is applied, a first electrode connected to the third connection node CN3, and a second electrode connected to the Q2 node Q2.

The thirteenth transistor T13 is turned on according to the potential of the Q2 node Q2 and outputs the low-potential voltage VGL to a second output node OUT2. The thirteenth transistor T13 includes a gate electrode connected to the Q2 node Q2, a first electrode connected to the second power line PL2, and a second electrode connected to the second output node OUT2.

The fourteenth transistor T14 is turned on according to the potential of the QB2 node QB2 and outputs the high-potential voltage VGH to the second output node OUT2. The fourteenth transistor T14 includes a gate electrode connected to the QB2 node QB2, a first electrode connected to the second output node OUT2, and a second electrode connected to the first power line PL1.

The fourth capacitor C4 is connected between the gate electrode and the first electrode of the tenth transistor T10. The fifth capacitor C5 is connected between the gate electrode and the second electrode of the thirteenth transistor T13. The sixth capacitor C6 is connected between the gate electrode and the second electrode of the fourteenth transistor T14.

In this configuration, in the multi-frequency driving mode, the control signal transfer part OUT outputs a control signal at a high-level voltage or outputs a control signal at a low-level voltage depending on potentials of the modified control clock signals CCLK1, CCLK2, CCLK3, and CCLK4 that are modulated according to a driving frequency for each display area. For example, the control signal transfer part OUT outputs the control signal MS4 at a high-level voltage when the modified control clock signal CCLK4 is at a high-level voltage, and outputs the control signal MS4 at a low-level voltage when the control clock signal CCLK4 is at a low-level voltage.

On the other hand, in the normal driving mode, not only are the modified control clock signals CCLK1, CCLK2, CCLK3, and CCLK4 not applied to the control signal transfer part OUT, but also the clock signals CLK1 and CLK2 are not applied to the carry signal transfer part CRY, so that they are not driven, thereby reducing power consumption.

All transistors constituting the gate driver according to the first embodiment of the present disclosure may be implemented as p-channel TFTs (thin film transistors), but are not limited thereto. For example, all transistors may be implemented as n-channel TFTs, or some transistors may be implemented as n-channel TFTs.

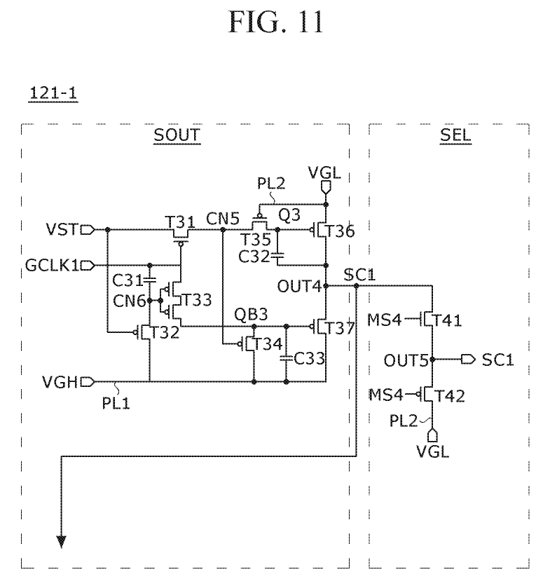

Referring to FIG. 11, which illustrates an example of a first signal transfer part included in the first scan driver 121-1 of the present disclosure, the first scan driver includes a scan signal output part SOUT and a scan signal selection part SEL.

The scan signal output part SOUT may output a first scan signal using gate clock signals GCLK1 and GCLK2, and a start pulse VST, or an (n-1)th gate signal GS(n-1) output from a previous signal transfer part. The scan signal output part SOUT includes a thirty-first transistor T31, a thirty-second transistor T32, a thirty-third transistor T33, a thirty-fourth transistor T34, a thirty-fifth transistor T35, a thirty-sixth transistor T36, a thirty-seventh transistor T37, a thirty-first capacitor C31, a thirty-second capacitor C32, and a thirty-third capacitor C33.

The thirty-first transistor T31 is turned on according to a gate clock signal GCLK1 and applies the start pulse VST or a gate signal GS1(n-1) output from a previous signal transfer part to a fifth connection node CN5. The thirty-first transistor T31 includes a gate electrode to which the gate clock signal GCLK1 is applied, a first electrode to which the start pulse VST or the gate signal GS1(n-1) output from a previous signal transfer part is applied, and a second electrode connected to the fifth connection node CN5.

The thirty-second transistor T32 is turned on according to the start pulse VST or the gate signal GS1(n-1) output from a previous signal transfer part and connects a sixth connection node CN6 to a first power line PL1 to which the high-potential voltage VGH is applied, thereby charging the sixth connection node CN6 to the high-potential voltage VGH. The thirty-second transistor T32 includes a gate electrode to which the start pulse VST or the gate signal GS1(n-1) output from a previous signal transfer part is applied, a first electrode connected to the sixth connection node CN6, and a second electrode connected to the first power line PL1.

The thirty-third transistor T33 is turned on according to the potential of the sixth connection node CN6 and applies the gate clock signal GCLK1 to a QB3 node QB3. The thirty-third transistor T33 includes a gate electrode connected to the sixth connection node CN6, a first electrode to which the gate clock signal GCLK1 is applied, and a second electrode connected to the QB3 node QB3.

The thirty-fourth transistor T34 is turned on according to the potential of the fifth connection node CN5, and connects the first power line PL1 to the QB3 node QB3, thereby charging the QB3 node QB3 to the high-potential voltage VGH. The thirty-fourth transistor T34 includes a gate electrode connected to the fifth connection node CN5, a first electrode connected to the QB3 node QB3, and a second electrode connected to the first power line PL1.

The thirty-first to thirty-fourth transistor T31, T32, T33, and T34 may have a dual gate structure to minimize or at least reduce current leakage.

The thirty-fifth transistor T35 is turned on according to the potential of the low-potential voltage VGL and connects the fifth connection node CN5 to a Q3 node Q3. The thirty-fifth transistor T35 includes a gate electrode connected to a second power line PL2 to which the low-potential voltage VGL is applied, a first electrode connected to the fifth connection node CN5, and a second electrode connected to the Q3 node Q3.

The thirty-sixth transistor T36 is turned on according to the potential of the Q3 node Q3 and outputs the low-potential voltage VGL to a fourth output node OUT4. The thirty-sixth transistor T36 includes a gate electrode connected to the Q3 node Q3, a first electrode connected to the second power line PL2, and a second electrode connected to the fourth output node OUT4.

The thirty-seventh transistor T37 is turned on according to the potential of the QB3 node QB3 and outputs the high-potential voltage VGH to the fourth output node OUT4. The thirty-seventh transistor T37 includes a gate electrode connected to the QB3 node QB3, a first electrode connected to the fourth output node OUT4, and a second electrode connected to the first power line PL1.

The thirty-first capacitor C31 is connected between the gate electrode and the first electrode of the thirty-third transistor T33. The thirty-second capacitor C32 is connected between the gate electrode and the second electrode of the thirty-sixth transistor T36. The thirty-third capacitor C33 is connected between the gate electrode and the second electrode of the thirty-seventh transistor T37.

The scan signal selection part SEL may selectively output the first scan signal SC1 or the low-potential voltage VGL based on the potential of the control signal MS4. The scan signal selection part SEL includes a forty-first transistor T41 and a forty-second transistor T42. The forty-first transistor T41 may be implemented as a p-channel TFT, and the forty-second transistor T42 may be implemented as an n-channel TFT.

The forty-first transistor T41 is turned on according to the potential of the control signal MS4 and outputs the first scan signal SCb to a fifth output node OUT5. The forty-first transistor T41 includes a gate electrode to which the control signal MS4 is applied, a first electrode connected to the fourth output node OUT4, and a second electrode connected to the fifth output node OUTb.

The forty-second transistor T42 is turned on according to the potential of the control signal MS4 and outputs the low-potential voltage VGL to the fifth output node OUT5. The forty-second transistor T42 includes a gate electrode connected to the control signal MS4, a first electrode connected to the second power line PL2, and a second electrode connected to the fifth output node OUT5.

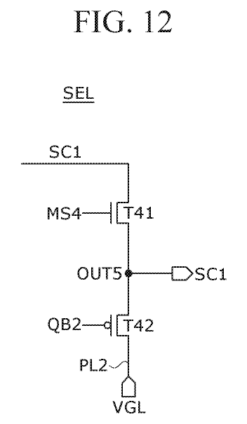

More specifically, as illustrated in FIG. 12, when the forty-second transistor T42 of the scan signal selection part SEL according to the comparative example is turned on according to the potential of the QB2 node in the control signal transfer part OUT illustrated in FIG. 10, the voltage of the QB2 node needs to be lower than VGL - |Vth|. For example, when the low-potential voltage VGL is -13V and the threshold voltage Vth is -3V, the low-potential voltage VGL needs to be less than -16V.

However, since it takes time for the voltage of the QB2 node to completely reach a target voltage, when the forty-second transistor T42 is controlled by the voltage of the QB2 node, not only does the low-potential voltage VGL need to be set to less than -16V, but also the driving voltage range of the gate driver increases as the low-potential voltage VGL is lowered, thereby increasing power consumption.

Therefore, in one or more embodiments, the forty-first transistor T41 and the forty-second transistor T42 may be configured to be immediately and completely turned on using the potential of the control signal MS4. When the potential of the control signal MS4 is used, there is no need to lower the low-potential voltage VGL. To this end, the forty-first transistor T41 is implemented as a p-channel TFT, and the forty-second transistor T42 is implemented as an n-channel TFT. This configuration may enable a reduction in power consumption in the embodiment.

In this configuration, in the multi-frequency driving mode, the scan signal selection part SEL outputs the low-potential voltage VGL or the first scan signal SC1 to the fifth output node OUT5 according to the potential of the control signal MS4.

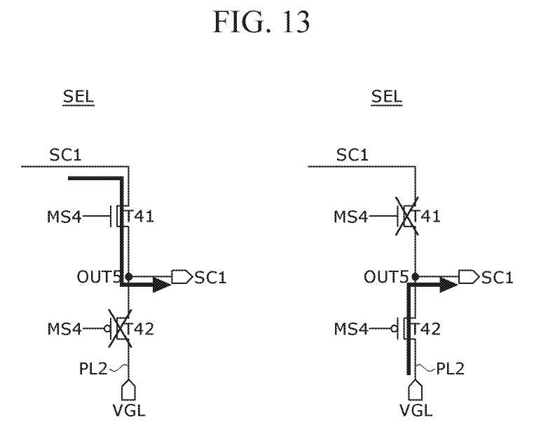

For example, as shown in FIG. 13, the scan signal selection part SEL outputs the first scan signal SC1 to the fifth output node OUT5 when the control signal MS4 is at a low-level voltage, and outputs the low-potential voltage VGL to the fifth output node OUT5 when the control signal MS4 is at a high-level voltage.

As an example, in accordance with the control signals MS1, MS2, MS3, and MS4 output as illustrated in FIG. 9, the scan signal output part SOUT outputs only some of the first scan signals.

On the other hand, in the normal driving mode, the scan signal selection part SEL outputs all of the first scan signals.

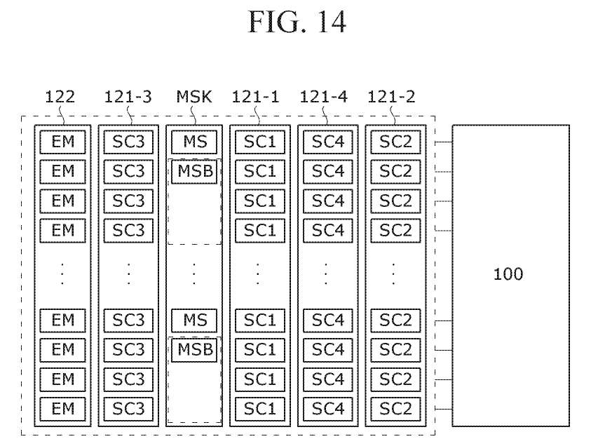

FIG. 14 is a diagram illustrating an arrangement form of a gate driver according to a second embodiment of the present disclosure.

Referring to FIG. 14, the gate driver according to a second embodiment of the present disclosure may include a first scan driver 121-1, a second scan driver 121-2, a third scan driver 121-3, a fourth scan driver 121-4, and an EM driver 122. In addition, in this embodiment, the gate driver may further include an output controller MSK that includes a circuit that outputs a control signal MS for controlling whether to output the first and second scan signals and the fourth scan signal, and a circuit that outputs an inverted control signal MSB.

As illustrated in FIG. 14, since the output controller MSK is disposed one for each of a plurality of scan drivers, there exists a dead space where no circuit is disposed. Therefore, in the embodiment, a circuit that outputs an inverted control signal MSB may be disposed in the dead space without requiring additional space.

In the multi-frequency driving mode, the first scan driver 121-1, the second scan driver 121-2, and the fourth scan driver 121-4 are controlled by the control signal MS and the inverted control signal MSB generated from the output controller MSK such that, among the first to fourth scan signals SC1, SC2, SC3, and SC4 and the EM signal EM to the pixel circuit of FIG. 2 driven during a skip frame period, the first scan signal SC1, the second scan signal SC2, and the fourth scan signal SC4 are not output to the pixel circuit of FIG. 2 driven during a skip frame period.

For example, the first scan driver 121-1 and the second scan driver 121-2 may be controlled by the control signal MS and the inverted control signal MSB, and the fourth scan driver 121-4 may be controlled by the control signal MS.

The output controller MSK may be disposed one per block, each block including a predetermined number of gate drivers so as to provide the same control signal and inverted control signal to a plurality of gate drivers, but is not limited thereto. For example, the output controller MSK may be disposed one for each gate driver so as to provide a control signal to each gate driver.

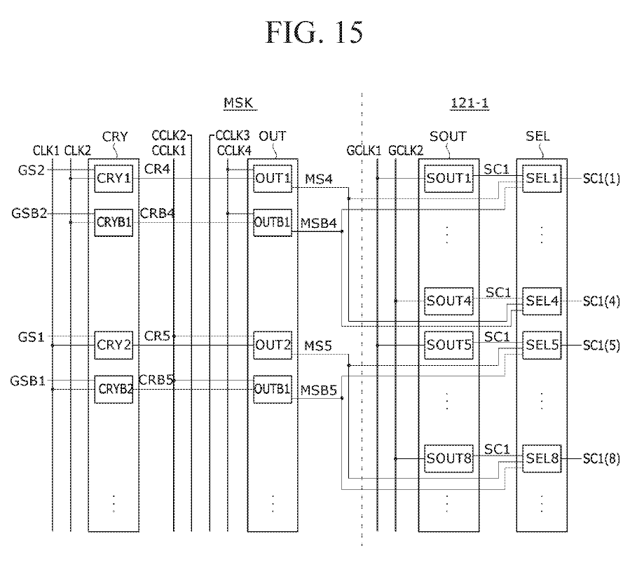

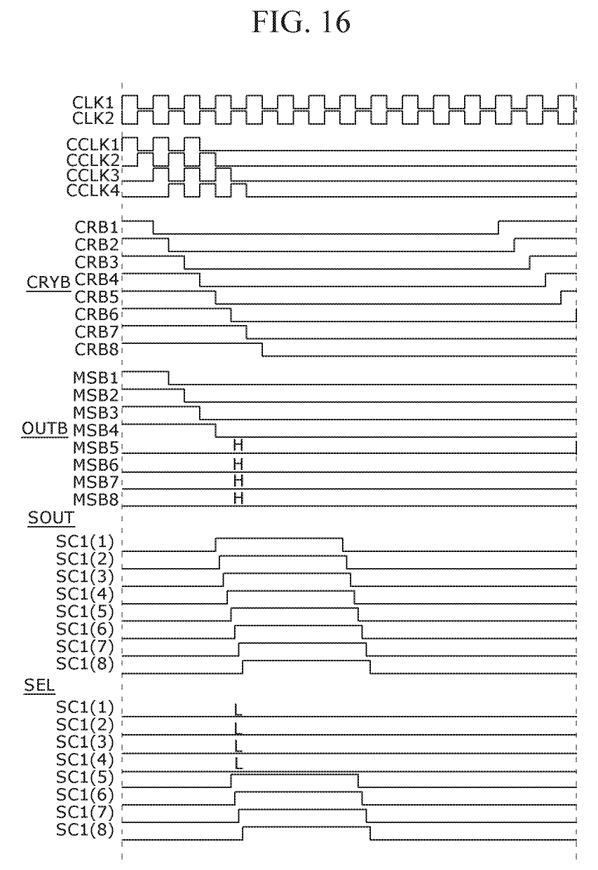

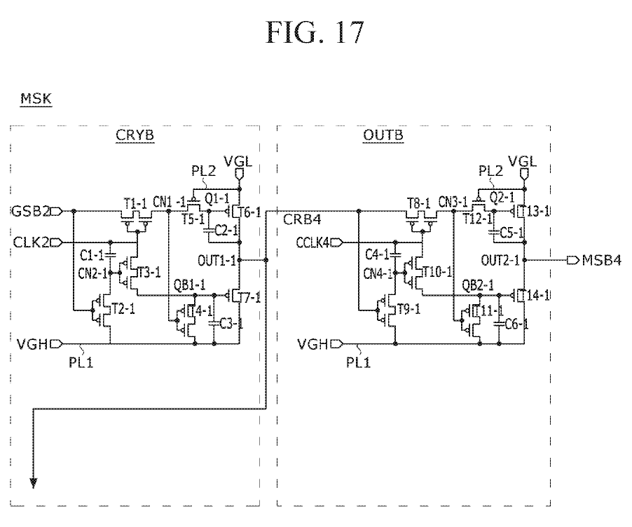

FIG. 15 is a block diagram illustrating a gate driver according to the second embodiment of the present disclosure. FIG. 16 is a diagram illustrating driving waveforms of the gate driver illustrated in FIG. 15. FIGS. 17-19 are diagrams illustrating detailed circuits of the gate driver illustrated in FIG. 15.

Referring to FIG. 15 and FIG. 16, the gate driver according to the second embodiment of the present disclosure may include an output controller MSK and a second scan driver 121-2 that outputs a second scan signal. The output controller MSK may include a carry signal transfer part CRY, a control signal transfer part OUT, an inverted carry signal transfer part CRYB, and an inverted control signal transfer part OUTB.

The driving waveforms of the carry signal transfer part CRY and the control signal transfer part OUT are the same as those in FIG. 9. The configuration and functions of the carry signal transfer part CRY and the control signal transfer part OUT are the same as those of the carry signal transfer part CRY and the control signal transfer part OUT illustrated in FIG. 10, and thus a description thereof will be omitted.

The inverted carry signal transfer part CRYB and the inverted control signal transfer part OUTB will be described. The inverted carry signal transfer part CRYB may receive selected inverted gate signals GSB1 and GSB2 and clock signals CLK1 and CLK2. The inverted gate signals GSB1 and GSB2 may be gate signals that are output from other gate drivers and sequentially shifted on a pixel line basis, for example, EM signals or separate gate signals. The inverted carry signal transfer parts CRYB may output inverted carry signals CRB4 and CRB5 under the control of the timing controller.

The inverted control signal transfer part OUTB may receive the inverted carry signals CRB4 and CRB5 and the control clock signals CCLK1, CCLK2, CCLK3, and CCLK4 to output inverted control signals MSB4 and MSB5.

As an example, as illustrated in FIG. 16, the inverted control signal transfer part OUTB may output only control signals MSB5, MSB6, MSB7, and MSB8 by the modulated control clock signals CCLK1, CCLK2, CCLK3, and CCLK4 in the multi-frequency driving mode.

The first scan driver 121-1 may selectively output the first scan signal SC1 or the low-potential voltage VGL based on the control signal MS and the inverted control signal MSB. The first scan driver 121-1 may include a scan signal output part SOUT and a scan signal selection part SEL.

The scan signal output part SOUT may output the first scan signal SC1 using the gate clock signals GCLK1 and GCLK2, and the start pulse VST or a gate signal output from a previous signal transfer part.

The scan signal selection part SEL may selectively output one of the first scan signal SC1 and the low-potential voltage VGL based on the potentials of the control signal MS and the inverted control signal MSB.

Referring to FIG. 17, which illustrates an example of a first signal transfer part included in the output controller MSK of the present disclosure, the output controller may include the inverted carry signal transfer part CRYB and the inverted control signal transfer part OUTB.

The inverted carry signal transfer part CRYB outputs an inverted carry signal CRB4 using the inverted gate signal GSB2 and the clock signal CLK2. The inverted carry signal transfer part CRYB includes a first-first transistor T1-1, a second-first transistor T2-1, a third-first transistor T3-1, a fourth-first transistor T4-1, a fifth-first transistor T5-1, a sixth-first transistor T6-1, a seventh-first transistor T7-1, a first capacitor C1-1, a second capacitor C2-1, and a third capacitor C3-1.

The first-first transistor T1-1 is turned on according to the clock signal CLK2 and applies the inverted gate signal GSB2 to a first-first connection node CN1-1. The first-first transistor T1-1 includes a gate electrode to which the clock signal CLK2 is applied, a first electrode to which the inverted gate signal GSB2 is applied, and a second electrode connected to the first-first connection node CN1-1.

The second-first transistor T2-1 is turned on according to the inverted gate signal GSB2 and connects a second-first connection node CN2-1 to the first power line PL1 to which the high-potential voltage VGH is applied, thereby charging the second-first connection node CN2-1 to the high-potential voltage VGH. The second-first transistor T2-1 includes a gate electrode to which the inverted gate signal GSB2 is applied, a first electrode connected to the second-first connection node CN2-1, and a second electrode connected to the first power line PL1.

The third-first transistor T3-1 is turned on according to the potential of the second-first connection node CN2-1 and applies the clock signal CLK2 to a QB1-1 node QB1-1. The third-first transistor T3-1 includes a gate electrode connected to the second-first connection node CN2-1, a first electrode to which the clock signal CLK2 is applied, and a second electrode connected to the QB1-1 node QB1-1.

The fourth-first transistor T4-1 is turned on according to the potential of the first-first connection node CN1-1 and connects the first power line PL1 to the QB1-1 node QB1-1, thereby charging the QB1-1 node QB1-1 to the high-potential voltage VGH. The fourth-first transistor T4-1 includes a gate electrode connected to the first-first connection node CN1-1, a first electrode connected to the QB1-1 node QB1-1, and a second electrode connected to the first power line PL1.

The fifth-first transistor T5-1 is turned on according to the potential of the low-potential voltage VGL and connects the first-first connection node CN1-1 and a Q1-1 node Q1-1. The fifth-first transistor T5-1 includes a gate electrode connected to a second power line PL2 to which the low-potential voltage VGL is applied, a first electrode connected to the first-first connection node CN1-1, and a second electrode connected to the Q1-1 node Q1-1.

The sixth-first transistor T6-1 is turned on according to the potential of the Q1-1 node Q1-1 and outputs the low-potential voltage VGL to a first-first output node OUT1-1. The sixth-first transistor T6-1 includes a gate electrode connected to the Q1-1 node Q1-1, a first electrode connected to the second power line PL2, and a second electrode connected to the first-first output node OUT1-1.

The seventh-first transistor T7-1 is turned on according to the potential of the QB1-1 node QB1-1 and outputs the high-potential voltage VGH to the first-first output node OUT1-1.

The seventh-first transistor T7-1 includes a gate electrode connected to the QB1-1 node QB1-1, a first electrode connected to the first-first output node OUT1-1, and a second electrode connected to the first power line PL1.

The first-first capacitor C1-1 is connected between the gate electrode and the first electrode of the third-first transistor T3-1. The second-first capacitor C2-1 is connected between the gate electrode and the second electrode of the sixth-first transistor T6-1. The third-first capacitor C3-1 is connected between the gate electrode and the second electrode of the seventh-first transistor T7-1.

The inverted control signal transfer part OUTB outputs an inverted control signal MSB4 based on the inverted carry signal CRB4 and the control clock signal CCLK4. The inverted control signal transfer part OUTB includes an eighth-first transistor T8-1, a ninth-first transistor T9-1, a tenth-first transistor T10-1, an eleventh-first transistor T11-1, a twelfth-first transistor T12-1, a thirteenth-first transistor T13-1, a fourteenth-first transistor T14-1, a fourth-first capacitor C4-1, a fifth-first capacitor C5-1, and a sixth-first capacitor C6-1.

The eighth-first transistor T8-1 is turned on according to the control clock signal CCLK4 and applies the inverted carry signal CRB4 to a third-first connection node CN3-1. The eighth -first transistor T8-1 includes a gate electrode to which the control clock signal CCLK4 is applied, a first electrode to which the inverted carry signal CRB4 is applied, and a second electrode connected to the third-first connection node CN3-1.

The ninth-first transistor T9-1 is turned on according to the inverted carry signal CRB4 and connects a fourth-first connection node CN4-1 to the first power line PL1 to which the high-potential voltage VGH is applied, thereby charging the fourth-first connection node CN4-1 to the high-potential voltage VGH. The ninth-first transistor T9-1 includes a gate electrode to which the inverted carry signal CRB4 is applied, a first electrode connected to the fourth-first connection node CN4-1, and a second electrode connected to the first power line PL1.

The tenth-first transistor T10-1 is turned on according to the potential of the fourth-first connection node CN4-1 and applies the control clock signal CCLK4 to a QB2-1 node QB2-1. The tenth-first transistor T10-1 includes a gate electrode connected to the fourth-first connection node CN4-1, a first electrode to which the control clock signal CCLK4 is applied, and a second electrode connected to the QB2-1 node QB2-1.

The eleventh-first transistor T11-1 is turned on according to the potential of the third-first connection node CN3-1 and connects the first power line PL1 to the QB2-1 node QB2-1, thereby charging the QB2-1 node QB2-1 to the high-potential voltage VGH. The eleventh-first transistor T11-1 includes a gate electrode connected to the third-first connection node CN3-1, a first electrode connected to the QB2-1 node QB2-1, and a second electrode connected to the first power line PL1.

The twelfth-first transistor T12-1 is turned on according to the potential of the low-potential voltage VGL and connects the third-first connection node CN3-1 to a Q2-1 node Q2-1. The twelfth-first transistor T12-1 includes a gate electrode connected to the second power line PL2 to which the low-potential voltage VGL is applied, a first electrode connected to the third-first connection node CN3-1, and a second electrode connected to the Q2-1 node Q2-1.

The thirteenth-first transistor T13-1 is turned on according to the potential of the Q2-1 node Q2-1 and outputs the low-potential voltage VGL to a second-first output node OUT2-1. The thirteenth-first transistor T13-1 includes a gate electrode connected to the Q2-1 node Q2-1, a first electrode connected to the second power line PL2, and a second electrode connected to the second-first output node OUT2-1.

The fourteenth-first transistor T14-1 is turned on according to the potential of the QB2-1 node QB2-1 and outputs the high-potential voltage VGH to the second-first output node OUT2-1. The fourteenth-first transistor T14-1 includes a gate electrode connected to the QB2-1 node QB2-1, a first electrode connected to the second-first output node OUT2-1, and a second electrode connected to the first power line PL1.

The fourth-first capacitor C4-1 is connected between the gate electrode and the first electrode of the tenth-first transistor T10-1. The fifth-first capacitor C5-1 is connected between the gate electrode and the second electrode of the thirteenth-first transistor T13-1. The sixth-first capacitor C6-1 is connected between the gate electrode and the second electrode of the fourteenth-first transistor T14-1.

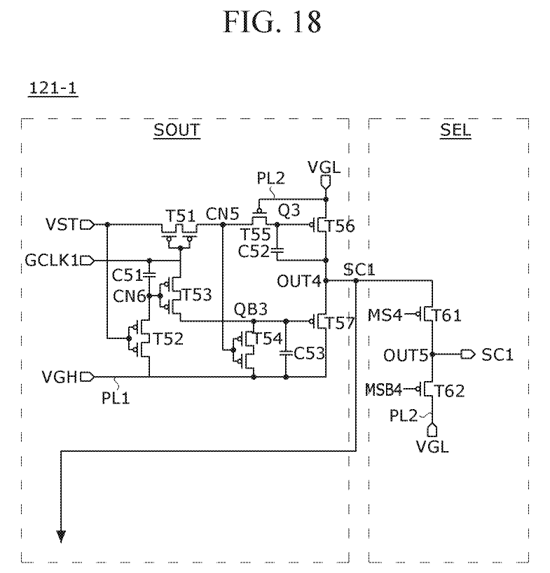

Referring to FIG. 18, which illustrates an example of a first signal transfer part included in the first scan driver 121-1 of the present disclosure, the first scan driver may include a scan signal output part SOUT and a scan signal selection part SEL.

The scan signal output part SOUT may output a first scan signal SC1 using gate clock signals GCLK1 and GCLK2, and a start pulse VST or an gate signal GS1(n-1) output from a previous signal transfer part. The scan signal output part SOUT includes a fifty-first transistor T51, a fifty-second transistor T52, a fifty-third transistor T53, a fifty-fourth transistor T54, a fifty-fifth transistor T55, a fifty-sixth transistor T56, a fifty-seventh transistor T57, a fifty-first capacitor C51, a fifty-second capacitor C52, and a fifty-third capacitor C53.

The fifty-first transistor T51 is turned on according to the gate clock signal GCLK1 and applies the start pulse VST or the gate signal GS1(n-1) output from the previous signal transfer part to the fifth connection node CN5. The fifty-first transistor T51 includes a gate electrode to which the gate clock signal GCLK1 is applied, a first electrode to which the start pulse VST or the gate signal GS1(n-1) output from the previous signal transfer part is applied, and a second electrode connected to a fifth connection node CN5.

The fifty-second transistor T52 is turned on according to the start pulse VST or the gate signal GS1(n-1) output from the previous signal transfer part and connects the sixth connection node CN6 to the first power line PL1 to which the high-potential voltage VGH is applied, thereby charging the sixth connection node CN6 to the high-potential voltage VGH. The fifty-second transistor T52 includes a gate electrode to which the start pulse VST or the gate signal GS1(n-1) output from the previous signal transfer part is applied, a first electrode connected to the sixth connection node CN6, and a second electrode connected to the first power line PL1.

The fifty-third transistor T53 is turned on according to the potential of the sixth connection node CN6 and applies the gate clock signal GCLK1 to the QB3 node QB3. The fifty-third transistor T53 includes a gate electrode connected to the sixth connection node CN6, a first electrode to which the gate clock signal GCLK1 is applied, and a second electrode connected to the QB3 node QB3.

The fifty-fourth transistor T54 is turned on according to the potential of the fifth connection node CN5 and connects the first power line PL1 to the QB3 node QB3, thereby charging the QB3 node QB3 to the high-potential voltage VGH. The fifty-fourth transistor T54 includes a gate electrode connected to the fifth connection node CN5, a first electrode connected to the QB3 node QB3, and a second electrode connected to the first power line PL1.

The fifty-first to fifty-fourth transistors T51, T52, T53, and T54 may have a dual gate structure to minimize or at least reduce current leakage.

The fifty-fifth transistor T55 is turned on according to the potential of the low-potential voltage VGL and connects the fifth connection node CN5 and a Q3 node Q3. The fifty-fifth transistor T55 includes a gate electrode connected to the second power line PL2 to which the low-potential voltage VGL is applied, a first electrode connected to the fifth connection node CN5, and a second electrode connected to the Q3 node Q3.

The fifty-sixth transistor T56 is turned on according to the potential of the Q3 node Q3 and outputs the low-potential voltage VGL to the fourth output node OUT4. The fifty-sixth transistor T56 includes a gate electrode connected to the Q3 node Q3, a first electrode connected to the second power line PL2, and a second electrode connected to the fourth output node OUT4.

The fifty-seventh transistor T57 is turned on according to the potential of the QB3 node QB3 and outputs the high-potential voltage VGH to the fourth output node OUT4. The fifty-seventh transistor T57 includes a gate electrode connected to the QB3 node QB3, a first electrode connected to the fourth output node OUT4, and a second electrode connected to the first power line PL1.

The fifty-first capacitor C51 is connected between the gate electrode and the first electrode of the fifty-third transistor T53. The fifty-second capacitor C52 is connected between the gate electrode and the second electrode of the fifty-sixth transistor T56. The fifty-third capacitor C53 is connected between the gate electrode and the second electrode of the fifty-seventh transistor T57.

The scan signal selection part SEL may selectively output the first scan signal SC1 based on the potentials of the control signal MS4 and the inverted control signal MSB4. The scan signal selection part SEL includes a sixty-first transistor T61 and a sixty-second transistor T62.

The sixty-first transistor T61 is turned on according to the potential of the control signal MS4 and applies the first scan signal SC1 to a fifth output node OUT5. The sixty-first transistor T61 includes a gate electrode to which the control signal MS4 is applied, a first electrode

connected to the fourth output node OUT4, and a second electrode connected to the fifth output node OUT5.

The sixty-second transistor T62 is turned on according to the potential of the inverted control signal MSB4 and applies the high-potential voltage VGH to the fifth output node OUT5. The sixty-second transistor T62 includes a gate electrode to which the inverted control signal MSB4 is applied, a first electrode connected to the fifth output node OUTb, and a second electrode connected to the first power line PL1.

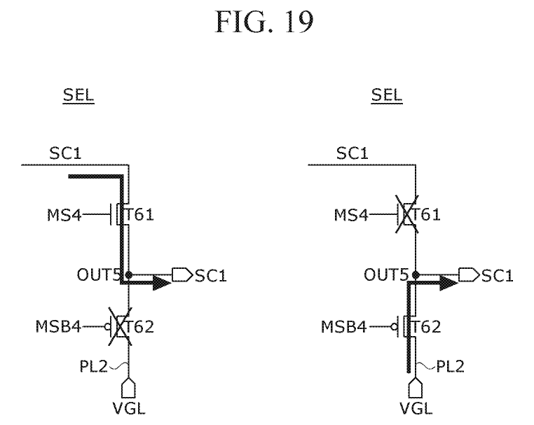

For example, as illustrated in FIG. 19, the scan signal selection part SEL may output the first scan signal SC1 to the fifth output node OUT5 when the control signal MS4 is at a low-level voltage and the inverted control signal MSB4 is at a high-level voltage, and may output the low-potential voltage VGL to the fifth output node OUT5 when the control signal MS4 is at a high-level voltage and the inverted control signal MSB4 is at a low-level voltage.

In this time, in the multi-frequency driving mode, the scan signal selection part SEL may output the first scan signal SC1 when the control signal MS4 is at a low-level voltage and the inverted control signal MSB4 is at a high-level voltage, and may output the low-potential voltage VGL when the control signal MS4 is at a high-level voltage and the inverted control signal MSB4 is at a low-level voltage.

On the other hand, in the general driving mode, the scan signal selection part SEL may output the first scan signal SC1.

Although the embodiments of the present disclosure have been described in more detail with reference to the accompanying drawings, the present disclosure is not limited thereto and may be embodied in many different forms without departing from the technical concept of the present disclosure. Therefore, the embodiments disclosed in the present disclosure are provided for illustrative purposes only and are not intended to limit the technical concept of the present disclosure. The scope of the technical concept of the present disclosure is not limited thereto. Therefore, it should be understood that the above-described embodiments are illustrative in all aspects and do not limit the present disclosure.

What is claimed is:

1. A gate driver, comprising:
a control signal transfer part configured to generate a control signal based on a control clock signal and a carry signal;
a scan signal output part configured to generate a scan signal according to potentials of a first control node and a second control node that are charged or discharged according to a gate clock signal; and
a scan signal selection part configured to selectively output the scan signal generated from the scan signal output part based on the control signal transmitted from the control signal transfer part,
wherein the scan signal selection part includes a first transistor implemented as a p-channel thin film transistor (TFT) and a second transistor implemented as an n-channel TFT,
wherein the first transistor includes a gate electrode to which the control signal is applied, a first electrode to which the scan signal is applied, and a second electrode connected to an output node, and
wherein the second transistor includes a gate electrode to which the control signal is applied, a first electrode connected to the output node, and a second electrode to which a low-potential voltage is applied.

2. The gate driver according to claim 1, further comprising:
a carry signal transfer part configured to output the carry signal based on a clock signal,
wherein the carry signal transfer part comprises:
a first transistor having a gate electrode to which the clock signal is applied, a first electrode to which a start pulse or a gate signal is applied, and a second electrode connected to a first connection node;
a second transistor having a gate electrode to which the start pulse or the gate signal is applied, a first electrode connected to a second connection node, and a second electrode to which a high-potential voltage is applied;
a third transistor having a gate electrode connected to the second connection node, a first electrode to which the clock signal is applied, and a second electrode connected to a first-second control node;
a fourth transistor having a gate electrode connected to the first connection node, a first electrode connected to the first-second control node, and a second electrode to which the high-potential voltage is applied;
a fifth transistor having a gate electrode to which the low-potential voltage is applied, a first electrode connected to the first connection node, and a second electrode connected to a first-first control node;
a sixth transistor having a gate electrode connected to the first-first control node, a first electrode to which the low-potential voltage is applied, and a second electrode connected to a first output node; and
a seventh transistor having a gate electrode connected to the first-second control node, a first electrode connected to the first output node, and a second electrode to which the high-potential voltage is applied.

3. The gate driver according to claim 2, wherein:
the control signal transfer part includes an eighth transistor, a ninth transistor, a tenth transistor, an eleventh transistor, a twelfth transistor, a thirteenth transistor, and a fourteenth transistor,
the eighth transistor includes a gate electrode to which the control clock signal is applied, a first electrode connected to the first output node, and a second electrode connected to a third connection node,
the ninth transistor includes a gate electrode connected to the first output node, a first electrode connected to a fourth connection node, and a second electrode to which the high-potential voltage is applied,
the tenth transistor includes a gate electrode connected to the fourth connection node, a first electrode to which the control clock signal is applied, and a second electrode connected to a second-second control node,
the eleventh transistor includes a gate electrode connected to the third connection node, a first electrode connected to the second-second control node, and a second electrode to which the high-potential voltage is applied,
the twelfth transistor includes a gate electrode to which the low-potential voltage is applied, a first electrode connected to the third connection node, and a second electrode connected to a second-first control node,
the thirteenth transistor includes a gate electrode connected to the second-first control node, a first electrode to which the low-potential voltage is applied, and a second electrode connected to a second output node, and
the fourteenth transistor includes a gate electrode connected to the second-second control node, a first electrode connected to the second output node, and a second electrode to which the high-potential voltage is applied.

4. A gate driver, comprising:
a control signal transfer part configured to generate a control signal based on a control clock signal and a carry signal;
an inverted control signal transfer part configured to generate an inverted control signal based on the control clock signal and an inverted carry signal;
a scan signal output part configured to generate a scan signal according to potentials of a first control node and a second control node that are charged or discharged according to a gate clock signal; and
a scan signal selection part configured to selectively output the scan signal generated from the scan signal output part based on the control signal transmitted from the control signal transfer part,
wherein the scan signal selection part includes a first transistor implemented as a p-channel thin film transistor (TFT) and a second transistor implemented as a p-channel TFT,
wherein the first transistor includes a gate electrode to which the control signal is applied, a first electrode to which the scan signal is applied, and a second electrode connected to an output node, and
wherein the second transistor includes a gate electrode to which the inverted control signal is applied, a first electrode connected to the output node, and a second electrode to which a low-potential voltage is applied.

5. The gate driver according to claim 4, further comprising:
an inverted carry signal transfer part that outputs the inverted carry signal based on a clock signal,
wherein the inverted carry signal transfer part includes:
a first-first transistor having a gate electrode to which the clock signal is applied, a first electrode to which an inverted gate signal is applied, and a second electrode connected to a first connection node;
a second-first transistor having a gate electrode to which a start pulse or a gate signal is applied, a first electrode connected to a second connection node, and a second electrode to which a high-potential voltage is applied;
a third-first transistor having a gate electrode connected to the second connection node, a first electrode to which the clock signal is applied, and a second electrode connected to a first-second control node;
a fourth-first transistor having a gate electrode connected to the first connection node, a first electrode connected to the first-second control node, and a second electrode to which the high-potential voltage is applied;
a fifth-first transistor having a gate electrode to which the low-potential voltage is applied, a first electrode connected to the first connection node, and a second electrode connected to a first-first control node;
a sixth-first transistor having a gate electrode connected to the first-first control node, a first electrode to which the low-potential voltage is applied, and a second electrode connected to a first output node; and
a seventh-first transistor having a gate electrode connected to the first-second control node, a first electrode connected to the first output node, and a second electrode to which the high-potential voltage is applied.

6. The gate driver according to claim 5, wherein:
the inverted control signal transfer part comprises an eighth-first transistor, a ninth-first transistor, a tenth-first transistor, an eleventh-first transistor, a twelfth-first transistor, a thirteenth-first transistor, and a fourteenth-first transistor,
the eighth-first transistor includes a gate electrode to which the control clock signal is applied, a first electrode connected to the first output node, and a second electrode connected to a third connection node,
the ninth-first transistor includes a gate electrode connected to the first output node, a first electrode connected to a fourth connection node, and a second electrode to which the high-potential voltage is applied,
the tenth-first transistor includes a gate electrode connected to the fourth connection node, a first electrode to which the control clock signal is applied, and a second electrode connected to a second-second control node,
the eleventh-first transistor includes a gate electrode connected to the third connection node, a first electrode connected to the second-second control node, and a second electrode to which the high-potential voltage is applied,
the twelfth-first transistor includes a gate electrode to which the low-potential voltage is applied, a first electrode connected to the third connection node, and a second electrode connected to a second-first control node,
the thirteenth-first transistor includes a gate electrode connected to the second-first control node, a first electrode to which the low-potential voltage is applied, and a second electrode connected to a second output node, and
the fourteenth-first transistor includes a gate electrode connected to the second-second control node, a first electrode connected to the second output node, and a second electrode to which the high-potential voltage is applied.

7. A display device, comprising:
a display panel on which a plurality of data lines are applied, a plurality of gate lines crossing the plurality of data lines are applied, a plurality of power lines to which different constant voltages are applied, and a plurality of sub-pixels are disposed;
a data driver configured to supply a data voltage of pixel data to the plurality of data lines;
a gate driver configured to supply a gate signal to the plurality of gate lines; and
a timing controller configured to control operation timings of the data driver and the gate driver,
wherein the gate driver comprises:
a control signal transfer part configured to generate a control signal based on a control clock signal and a carry signal;
a scan signal output part configured to generate a scan signal according to potentials of a first control node and a second control node that are charged or discharged according to a gate clock signal; and
a scan signal selection part configured to selectively output the scan signal generated from the scan signal output part based on the control signal transmitted from the control signal transfer part,
wherein the scan signal selection part includes a first transistor implemented as a p-channel thin film transistor (TFT) and a second transistor implemented as an n-channel TFT,
wherein the first transistor includes a gate electrode to which the control signal is applied, a first electrode to which the scan signal is applied, and a second electrode connected to an output node, and
wherein the second transistor includes a gate electrode to which the control signal is applied, a first electrode to the output node, and a second electrode connected to which a low-potential voltage is applied.

8. The display device according to claim 7, further comprising:
a carry signal transfer part configured to output the carry signal based on a clock signal,
wherein the carry signal transfer part includes:
a first transistor having a gate electrode to which the clock signal is applied, a first electrode to which a start pulse or a gate signal is applied, and a second electrode connected to a first connection node;
a second transistor having a gate electrode to which the start pulse or the gate signal is applied, a first electrode connected to a second connection node, and a second electrode to which a high-potential voltage is applied;
a third transistor having a gate electrode connected to the second connection node, a first electrode to which the clock signal is applied, and a second electrode connected to a first-second control node;
a fourth transistor having a gate electrode connected to the first connection node, a first electrode connected to the first-second control node, and a second electrode to which the high-potential voltage is applied;
a fifth transistor having a gate electrode to which the low-potential voltage is applied, a first electrode connected to the first connection node, and a second electrode connected to a first-first control node;
a sixth transistor having a gate electrode connected to the first-first control node, a first electrode to which the low-potential voltage is applied, and a second electrode connected to a first output node; and
a seventh transistor having a gate electrode connected to the first-second control node, a first electrode connected to the first output node, and a second electrode to which the high-potential voltage is applied.

9. The display device according to claim 8, wherein:
the control signal transfer part includes an eighth transistor, a ninth transistor, a tenth transistor, an eleventh transistor, a twelfth transistor, a thirteenth transistor, and a fourteenth transistor,
the eighth transistor includes a gate electrode to which the control clock signal is applied, a first electrode connected to the first output node, and a second electrode connected to a third connection node,
the ninth transistor includes a gate electrode connected to the first output node, a first electrode connected to a fourth connection node, and a second electrode to which the high-potential voltage is applied,
the tenth transistor includes a gate electrode connected to the fourth connection node, a first electrode to which the control clock signal is applied, and a second electrode connected to a second-second control node,
the eleventh transistor includes a gate electrode connected to the third connection node, a first electrode connected to the second-second control node, and a second electrode to which the high-potential voltage is applied,
the twelfth transistor includes a gate electrode to which the low-potential voltage is applied, a first electrode connected to the third connection node, and a second electrode connected to a second-first control node,
the thirteenth transistor includes a gate electrode connected to the second-first control node, a first electrode to which the low-potential voltage is applied, and a second electrode connected to a second output node, and
the fourteenth transistor includes a gate electrode connected to the second-second control node, a first electrode connected to the second output node, and a second electrode to which the high-potential voltage is applied.

10. A display device, comprising:
a display panel on which a plurality of data lines are applied, a plurality of gate lines crossing the plurality of data lines are applied, a plurality of power lines to which different constant voltages are applied, and a plurality of sub-pixels are disposed;
a data driver configured to supply a data voltage of pixel data to the plurality of data lines;
a gate driver configured to supply a gate signal to the plurality of gate lines; and
a timing controller configured to control operation timings of the data driver and the gate driver,
wherein the gate driver includes:
a control signal transfer part configured to generate a control signal based on a control clock signal and a carry signal;
an inverted control signal transfer part configured to generate an inverted control signal based on the control clock signal and an inverted carry signal;
a scan signal output part configured to generate a scan signal according to potentials of a first control node and a second control node that are charged or discharged according to a gate clock signal; and
a scan signal selection part configured to selectively output the scan signal generated from the scan signal output part based on the control signal transmitted from the control signal transfer part,
wherein the scan signal selection part includes a first transistor implemented as a p-channel thin film transistor (TFT) and a second transistor implemented as a p-channel TFT, and
wherein the first transistor includes a gate electrode to which the control signal is applied, a first electrode to which the scan signal is applied, and a second electrode connected to an output node, and
wherein the second transistor includes a gate electrode to which the inverted control signal is applied, a first electrode connected to the output node, and a second electrode to which a low-potential voltage is applied.

11. The display device according to claim 10, further comprising:
an inverted carry signal transfer part that outputs the inverted carry signal based on a clock signal,
wherein the inverted carry signal transfer part includes:
a first transistor having a gate electrode to which the clock signal is applied, a first electrode to which an inverted gate signal is applied, and a second electrode connected to a first connection node;
a second transistor having a gate electrode to which a start pulse or the gate signal is applied, a first electrode connected to a second connection node, and a second electrode to which a high-potential voltage is applied;
a third transistor having a gate electrode connected to the second connection node, a first electrode to which the clock signal is applied, and a second electrode connected to a first-second control node;
a fourth transistor having a gate electrode connected to the first connection node, a first electrode connected to the first-second control node, and a second electrode to which the high-potential voltage is applied;
a fifth transistor having a gate electrode to which the low-potential voltage is applied, a first electrode connected to the first connection node, and a second electrode connected to a first-first control node;
a sixth transistor having a gate electrode connected to the first-first control node, a first electrode to which the low-potential voltage is applied, and a second electrode connected to a first output node; and
a seventh transistor having a gate electrode connected to the first-second control node, a first electrode connected to the first output node, and a second electrode to which the high-potential voltage is applied.

12. The display device according to claim 11, wherein the inverted control signal transfer part comprises an eighth transistor, a ninth transistor, a tenth transistor, an eleventh transistor, a twelfth transistor, a thirteenth transistor, and a fourteenth transistor,
wherein the eighth transistor includes a gate electrode to which the control clock signal is applied, a first electrode connected to the first output node, and a second electrode connected to a third connection node,
wherein the ninth transistor includes a gate electrode connected to the first output node, a first electrode connected to a fourth connection node, and a second electrode to which the high-potential voltage is applied,
wherein the tenth transistor includes a gate electrode connected to the fourth connection node, a first electrode to which the control clock signal is applied, and a second electrode connected to a second-second control node,
wherein the eleventh transistor includes a gate electrode connected to the third connection node, a first electrode connected to the second-second control node, and a second electrode to which the high-potential voltage is applied,
wherein the twelfth transistor includes a gate electrode to which the low-potential voltage is applied, a first electrode connected to the third connection node, and a second electrode connected to a second-first control node,
wherein the thirteenth transistor includes a gate electrode connected to the second-first control node, a first electrode to which the low-potential voltage is applied, and a second electrode connected to a second output node, and
wherein the fourteenth transistor includes a gate electrode connected to the second-second control node, a first electrode connected to the second output node, and a second electrode to which the high-potential voltage is applied.
